(19) United States
(12) Patent Application Publication
(10) Pub. No.: US 2022/0391672 A1
(43) Pub. Date: Dec. 8, 2022

(54) MULTI-TASK DEPLOYMENT METHOD AND ELECTRONIC DEVICE

(71) Applicant: Beijing Baidu Netcom Science Technology Co., Ltd., Beijing (CN)

(72) Inventors: Kafeng Wang, Beijing (CN); Haoyi Xiong, Beijing (CN); Chengzhong Xu, Beijing (CN); Dejing Dou, Beijing (CN)

(73) Assignee: Beijing Baidu Netcom Science Technology Co., Ltd., Beijing (CN)

(21) Appl. No.: 17/820,972

(22) Filed: Aug. 19, 2022

(30) Foreign Application Priority Data
Aug. 25, 2021 (CN) 202110981600.0

(51) Int. Cl. G06N 3/04; G06F 9/48

(52) U.S. Cl. CPC G06N 3/0454; G06F 9/4881

(57) ABSTRACT

The disclosure provides a multi-task deployment method, and an electronic device. The method includes: obtaining N first tasks and K network models, in which N and K are positive integers greater than or equal to 1; allocating the N first tasks to the K network models differently for operation, to obtain at least one candidate combination of tasks and network models, in which each candidate combination includes a mapping relation between the N first tasks and the K network models; selecting a target combination with a maximum combination operation accuracy from the at least one candidate combination; and deploying a target mapping relation comprised in the target combination and the K network models on a prediction machine.

### CROSS REFERENCE TO RELATED APPLICATIONS

This application is based on and claims priority to Chinese patent applications Serial No. 202110981600.0 filed on Aug. 25, 2021, the entire contents of which are incorporated herein by reference.

### TECHNICAL FIELD

The disclosure relates to a field of computer technologies, especially a field of artificial intelligence (AI) technologies such as big data and deep learning, in particular to a multi-task deployment method, and an electronic device.

### BACKGROUND

Recently, deep learning technology has been rapidly applied to business scenarios in various industries due to its ability to reduce the usage complexity and the difficulty of understanding the technology.

Generally, the existing deep learning system is configured with one or more trained deep learning models based on experience. However, the usage time and the model chosen to run a certain task are not precisely designed, especially when complex task change occurs, it is difficult to match a deep learning model to a task empirically to ensure real-time schedulability. Therefore, how to choose a suitable deep learning model has become a problem that needs to be solved urgently.

### SUMMARY

The embodiments of the disclosure provide a multi-task deployment method, and an electronic device.

According to a first aspect of the disclosure, a multi-task deployment method is provided. The method includes: obtaining N first tasks and K network models, in which N and K are positive integers greater than or equal to 1; allocating the N first tasks to the K network models for operation, to obtain at least one candidate combination of tasks and network models, in which each candidate combination includes a mapping relation between the N first tasks and the K network models; selecting a target combination with a maximum combination operation accuracy from the at least one candidate combination; and deploying a target mapping relation included in the target combination and the K network models on a prediction machine.

According to a second aspect of the disclosure, an electronic device is provided. The electronic device includes: at least one processor and a memory communicatively coupled to the at least one processor. The memory stores instructions executable by the at least one processor, and when the instructions are executed by the at least one processor, the at least one processor is enabled to implement the method according to the first aspect of the disclosure.

According to a third aspect of the disclosure, a non-transitory computer-readable storage medium storing computer instructions is provided. The computer instructions are configured to cause a computer to implement the method according to the first aspect of the disclosure.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a flowchart of a multi-task deployment method according to an embodiment of the disclosure.

FIG. 2 is a flowchart of a multi-task deployment method according to an embodiment of the disclosure.

FIG. 3 is a flowchart of a multi-task deployment method according to an embodiment of the disclosure.

FIG. 4 is a flowchart of a multi-task deployment method according to an embodiment of the disclosure.

FIG. 5 is a flowchart of a multi-task deployment method according to an embodiment of the disclosure.

FIG. 6 is a flowchart of a multi-task deployment method according to an embodiment of the disclosure.

FIG. 7 is a flowchart of a multi-task deployment method according to an embodiment of the disclosure.

FIG. 8 is a flowchart of a multi-task deployment method according to an embodiment of the disclosure.

FIG. 9 is a flowchart of a multi-task deployment method according to an embodiment of the disclosure.

FIG. 10 is a flowchart of a multi-task deployment method according to an embodiment of the disclosure.

FIG. 11 is a flowchart of a multi-task deployment method according to an embodiment of the disclosure.

FIG. 12 is a flowchart of a multi-task deployment method according to an embodiment of the disclosure.

FIG. 13 is an overall flowchart of a multi-task deployment method according to an embodiment of the disclosure.

FIG. 14 is a block diagram of a multi-task deployment apparatus according to an embodiment of the disclosure.

FIG. 15 is a block diagram of an electronic device used to implement a multi-task deployment method according to an embodiment of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

A multi-task deployment method, a multi-task deployment apparatus, an electronic device and a storage medium according to the embodiments of the disclosure are described with reference to the accompanying drawings.

Natural Language Processing (NLP) is an important direction in the fields of computer science and AI, which studies various theories and methods that can realize effective human-computer communication based on natural language. NLP is a science that integrates linguistics, computer science and mathematics. NLP is mainly used in machine translation, public opinion monitoring, automatic summarization, opinion extraction, text classification, question answering, text semantic comparison, and speech recognition.

Deep Learning (DL) is a new research direction in the field of Machine Learning (ML), which is introduced into ML to make it closer to the original goal-AI. DL aims to learn the intrinsic laws and representation levels of sample data, and the information obtained during these learning processes is of great help in the interpretation of data such as text, images and sounds. The ultimate goal of DL is to enable machines to have the ability to analyze and learn like human, and to recognize data such as words, images and sounds. DL is a complex machine learning algorithm that has achieved results in speech and image recognition far exceeding the related art.

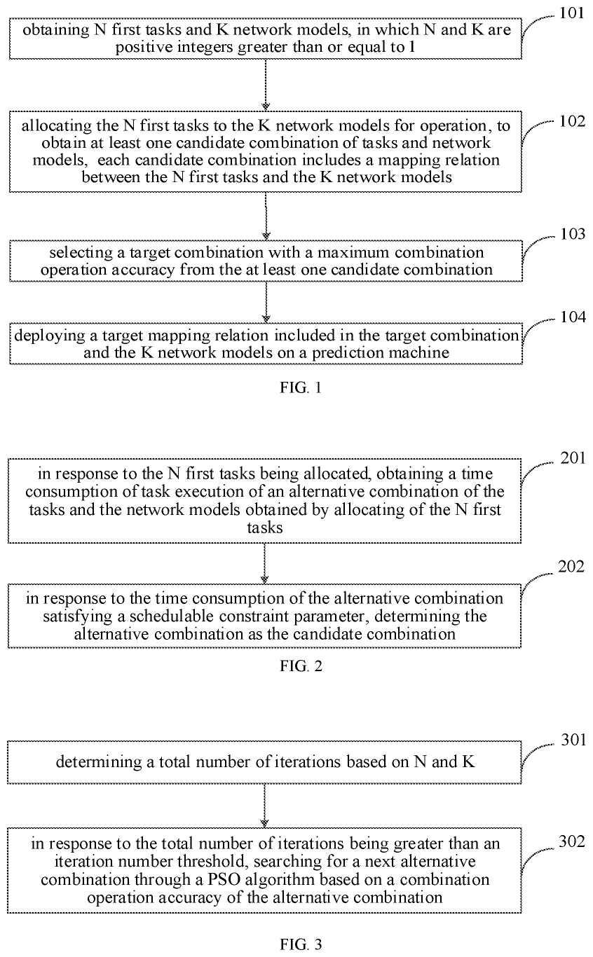

FIG. 1 is a flowchart of a multi-task deployment method according to an embodiment of the disclosure.

As illustrated in FIG. 1, the multi-task deployment method includes the following steps. At block S101, N first tasks and K network models are obtained, N and K are positive integers greater than or equal to 1.

The multi-task deployment method of the embodiments of the disclosure may be performed by an electronic device, and the electronic device may be a Personal Computer (PC), a server or the like. Alternatively, the server may be a cloud server.

There may be various types of first tasks. For example, the first task may be image detection, image type recognition, image dividing and the like. Correspondingly, the network model may be an image detection model, an image type recognition model and an image dividing model. It should be noted that the network model described in this embodiment is trained in advance and stored in a storage space of the electronic device for easy retrieval and use.

In the embodiment of the disclosure, there may be various methods for acquiring the N first tasks. Alternatively, N images may be collected, each image corresponding to a first task. The images can be collected in real time or obtained from an image library. Alternatively, the N first tasks may be input into the electronic device, and the task may be an image processing task.

At block S102, the N first tasks are allocated to the K network models for operation, to obtain at least one candidate combination of tasks and network models, in which each candidate combination includes a mapping relation between the N first tasks and the K network models.

In the embodiment of the disclosure, the N first tasks may be respectively allocated to the K network models for operation. For example, there are 10 tasks and 5 network models, task 1 and task 2 are allocated to the network model 1, tasks 3 and 4 are assigned to the network model 2, tasks 5 and 6 are assigned to the network model 3, tasks 7 and 8 are assigned to the network model 4, and tasks 9 and 10 are assigned to the network model 5. After the operation is completed, the N first tasks are reassigned to the K network models for operation, for example, task 1 and task 9 are assigned to the network model 1, and task 2 and task 10 are assigned to the network model 2, task 3 and task 7 are assigned to the network model 3, task 6 and task 8 are assigned to the network model 4, and task 2 and task 5 are assigned to the network model 5. The above steps are repeated until all possible assignments are adopted, to output at least one candidate combination. It should be noted that the task-network model combinations generated by assigning the N first tasks to the K network models each time are different, that is, the mapping relation between the tasks and the network models is distinct in the task-network model combinations.

It should be noted that the mapping relation described in this embodiment is a corresponding relation between the N first tasks and the K network models in the candidate combinations. On the basis of the above examples, the mapping relation includes the mapping between tasks 1 and 9 and the network model 1, the mapping between tasks 2 and 10 and the network model 2, the mapping between tasks 3 and 7 and the network model 3, the mapping between tasks 6 and 8 and the network model 4, and the mapping between tasks 2 and 5 and the network model 5.

At block S103, a target combination with a maximum combination operation accuracy is selected from the at least one candidate combination.

After the N first tasks are differently allocated to the K network models for operation, at least one candidate combination is generated, and the combination operation accuracy of the candidate combination can be calculated. It is understood that the larger the combination operation accuracy of the candidate combination, the larger the operation accuracy and the operation efficiency of the N first tasks using the candidate combination, so the candidate combination with the maximum combination operation accuracy is determined as the target combination.

Alternatively, when there is only one candidate combination, the candidate combination is determined as the target combination.

Alternatively, when there are multiple candidate combinations, the candidate combination with the maximum combination operation accuracy can be selected as the target combination by comparing the combination operation accuracies of the multiple candidate combinations.

In the embodiment of the disclosure, the candidate combinations may be processed by a combination operation accuracy algorithm, to generate the combination operation accuracy of each of the multiple candidate combinations. The algorithm can be set in advance and stored in the storage space of the electronic device for easy retrieval and use when needed.

At block S104, a target mapping relation included in the target combination and the K network models are deployed on a prediction machine.

In the embodiment of the disclosure, the prediction machine is a device that directly performs prediction, and the device can predict the task through the deployed network model, and output a prediction result.

After the target mapping relation included in the target combination and the K network models are deployed on the prediction machine, in response to receiving a first task, the corresponding network model in the K network models can be called based on the target mapping relation, and the operation on the first task can be performed by the corresponding network model. By matching the tasks with the network models, the optimal combination of tasks and network models can be obtained, thereby improving the timeliness and accuracy of task processing.

In the above embodiment, the process of allocating the N first tasks to the K network models for operation, to obtain the at least one candidate combination of the tasks and the network models, is further explained in combination with FIG. 2. As illustrated in FIG. 2, the above process includes the following steps.

At block 5201, in response to the N first tasks being allocated, a time consumption of task execution of an alternative combination of the tasks and the network models obtained by allocating of the N first tasks is obtained.

In the embodiment of the disclosure, when different first tasks are processed through different network, and the required time consumption may be different.

Alternatively, when the same first task is processed by different network models, the time consumption required for task execution may be different.

Alternatively, when different first tasks are processed by the same network model, the time consumption required for task execution may be different.

At block 5202, in response to the time consumption of the alternative combination satisfying a schedulable constraint parameter, the alternative combination is determined as the candidate combination.

In the embodiment of the disclosure, when the time consumption of the alternative combination is less than the schedulable constraint parameter, the alternative combination may be considered to be within a schedulable range, and the alternative combination may be determined as the candidate combination.

It should be noted that when different scheduling algorithms are used, the schedulable constraint parameter may be different. For example, when the system uses the Earliest Deadline First (EDF) scheduling algorithm, a constraint value for system usage rate can be 100% to ensure its schedulability. When the system adopts the Response Time (RM) algorithm, its constraint value for the system usage rate can be 70%.

Each time after completing the allocation of the N first tasks, the time consumption of task execution of the alternative combination of the tasks and the network models is obtained. In response to the time consumption of the alternative combination satisfying a schedulable constraint parameter, the alternative combination is determined as the candidate combination. Therefore, the combinations with a poor schedulability are filtered out from the candidate combinations based the schedulable constraint parameter, so that the range of determining the target combination is narrowed, the efficiency is improved, the cost is reduced, and the schedulability is improved.

Alternatively, in response to the time consumption of the alternative combination not satisfying the schedulable constraint parameter, the alternative combination is discarded, and a next alternative combination is acquired. In this way, the alternative combinations can be traversed, to select the candidate combinations that meet the schedulable constraint parameter, which provides a basis for subsequent determination of the target combination from the candidate combinations.

In the above embodiment, the method for generating the candidate combination can also be further explained with FIG. 3. As illustrated in FIG. 3, the method includes the following steps.

At block 5301, a total number of iterations is determined based on N and K.

In the embodiment of the disclosure, the EDF scheduling algorithm can be used for design.

When there are N first tasks and K network models, the total number of iterations is K^{N} .

At block 5302, in response to the total number of iterations being greater than an iteration number threshold, a next alternative combination is searched through a Particle Swarm Optimization (PSO) algorithm based on a combination operation accuracy of the alternative combination.

In the implementation, when the total number of iterations is too large, the computing capacity of the system may be exceeded. In this case, if the N first tasks are differently allocated to the K network models for operation, the cost is very high. Therefore, the next available model combination can be searched from the K network models through the PSO algorithm, and the N first tasks can be processed through the model combination.

In detail, the PSO algorithm uses all possible combinations as particles to generate a search space. A fitness value of each particle is obtained based on the combination operation accuracy of the alternative combination. A global optimal position (Pbest) and a global extreme value (Gbest) are updated according to the fitness value, and position and speed of the particle is also updated. It is determined whether Gbest reaches a maximum number of iterations or whether the Pbest satisfies a minimum limit, if not, a new particle is searched and the above steps are repeated. If one of the above conditions is met, the particle is sent to the network model for operation in the PSO algorithm. It should be noted that the minimum limit described in this embodiment is set in advance and can be modified according to actual needs.

It should be noted that the iteration number threshold is not unique, and can be set according to the computing capability of the electronic device and time consumption, which is not limited herein.

In the embodiment of the disclosure, firstly, the total number of iterations is determined according to N and K. In response to the number of iterations being greater than the iteration number threshold, the next alternative combination is searched through the PSO algorithm based on the combination operation accuracy of the current alternative combination. Therefore, in some cases where the amount of data is relatively large, the PSO algorithm can be used to filter the alternative combinations, thereby reducing the amount of operation data and reducing the cost.

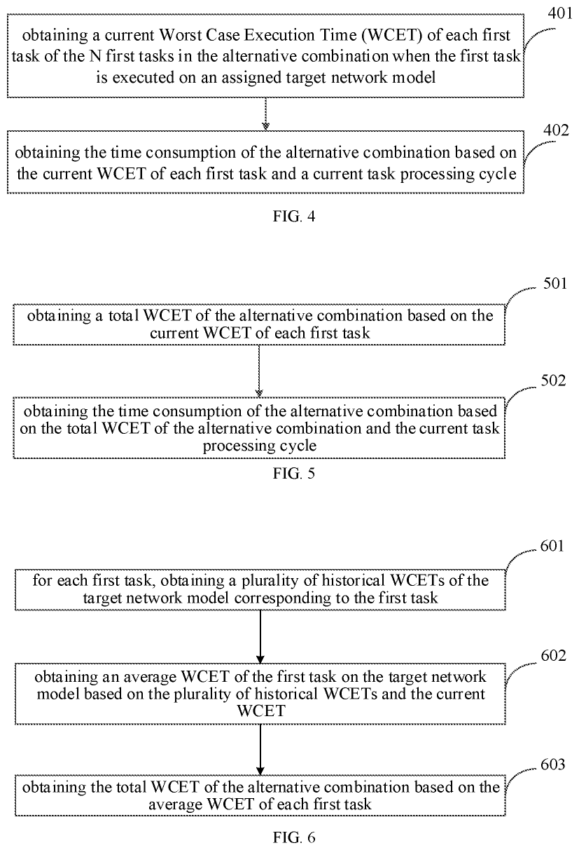

In the above embodiment, obtaining the time consumption of task execution of the alternative combination of the tasks and the network models can be further explained by FIG. 4. As illustrated in FIG. 4, the method includes the following steps.

At block 5401, a Worst Case Execution Time (WCET) of each of the N first tasks in the alternative combination executed on an assigned target network model is obtained.

In the implementation, considering the jitter of the calculation time of each network model, a processing duration of the first task on the target network model is not unique, and the WCET is a maximum time period during which the first task is executed on the target model.

In the embodiment of the disclosure, the WCET of the first task may be calculated by a WCET generation algorithm. It should be noted that due to the jitter in the calculation time of the target network model, the value of WCET is not fixed but oscillates back and forth around a fixed value.

At block 5402, the time consumption of the alternative combination is obtained based on the WCET of each of the first tasks and a task processing cycle.

In the embodiment of the disclosure, in a scenario of scheduling based on the EDF algorithm, formula (1) can be used to obtain the time consumption of the alternative combination, and the formula (1) is expressed by:

$$s . t . {U}_{EDF} = \frac{{\sum }_{i = 1}^{N} {t}_{i}^{j}}{T} \qquad ( 1 )$$

tᵢ^{j} the WCET when the j^{th}first task is operated by the j^{th}network model, and T is the task processing cycle. It should be noted that all tasks need to be executed within the task processing cycle, that is, the K network models need to process the N first tasks within the task processing cycle T.

In the embodiment, WCET of each of the N first tasks in the alternative combination executed on an assigned target network model is obtained. Based on the WCET of each of the N first tasks and the task processing cycle, the time consumption of the alternative combination is obtained. Therefore, by screening the alternative combinations based on the WCET of the task, the number of the alternative tasks is decreased and the accuracy of the target combination is improved.

In the above embodiment, the process of obtaining the time consumption of the alternative combination based on the WCET of each first task can be further explained by FIG. 5. As illustrated in FIG. 5, the method includes the following steps.

At block S501, a total WCET of the alternative combination is obtained based on the WCET of each first task.

Alternatively, as illustrated in formula (1), when obtaining the time consumption of the alternative combination based on the EDF algorithm, the total WCET can be expressed as Σᵢ₌₁^{N}tᵢ^{j}.

It can be seen that the larger N is (that is, the larger the number of first tasks), the larger the value of the total WCET. It is not difficult to understand that the more first tasks there are, the longer the corresponding processing duration of the first tasks is.

At block S502, the time consumption of the alternative combination is obtained based on the total WCET of the alternative combination and the task processing cycle.

Alternatively, as illustrated in formula (1), when the total WCET of the alternative combination is obtained, the WCET of each first task is summed to obtain the total WCET of the alternative combination. Further, the time consumption of the alternative combination is obtained based on a ratio of the total WCET to the task processing cycle.

In the embodiment of the disclosure, the total WCET of the alternative combination is obtained according to the WCET of each first task, and then the time consumption of the alternative combination is obtained according to the total WCET of the alternative combination and the task processing cycle. In this way, the time consumption of the alternative combination in the cycle is obtained, and the alternative combination is screened out by determining whether the alternative combination satisfies the schedulable parameter based on the time consumption.

In the above embodiment, the process of obtaining the total WCET of the alternative combination according to the WCET of each task is further explained by FIG. 6. As illustrated in FIG. 6, the method includes the following steps.

At block S601, for each first task, a plurality of historical WCETs of the target network model corresponding to the first task are obtained.

Alternatively, the plurality of historical WCETs of the target network model corresponding to the first task may be acquired by accessing a database. It should be noted that the database may store the mapping relation between the historical WCETs and the first task. The database may be stored in the storage space of the electronic device, or may be located on a server.

Alternatively, the plurality of historical WCETs can be obtained by inputting the first task into a historical WCET generation algorithm.

At block S602, an average WCET of the first task on the target network model is obtained based on the plurality of historical WCETs and the current WCET.

In the embodiment of the disclosure, due to the jitter of the calculation time of each network model, the values of the plurality of historical WCETs may be different, and the average WCET may be obtained by averaging the plurality of historical WCETs and the current WCET.

At block S603, the total WCET of the alternative combination is obtained based on the average WCET of each first task.

In the embodiment of the disclosure, the total WCET is calculated based on the EDF algorithm, and the calculation formula can be Σᵢ₌₁^{N}tᵢ^{-j}.

In the embodiment of the disclosure, for each first task, the historical WCETs of the target network model corresponding to the first task are obtained. The average WCET of the first task on the target network model is obtained based on the historical WCETs and the current WCET.

The total WCET of the alternative combination is obtained based on the average WCET of the first task. Therefore, by calculating the average WCET, the influence of the jitter of the model calculation time on the operation result can be reduced, and the stability of the system can be increased.

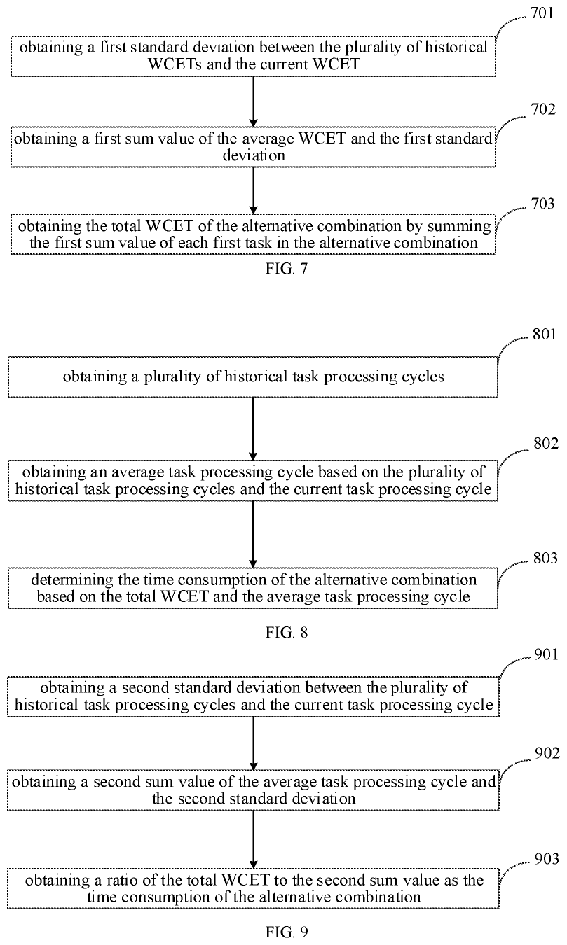

In the above embodiment, the process of obtaining the total WCET of the alternative combination according to the average WCET is further explained in combination with FIG. 7. As illustrated in FIG. 7, the method includes the following steps.

At block S701, a first standard deviation of the plurality of historical WCETs and the current WCET is obtained.

In the embodiment of the disclosure, the first standard deviation 6 of the WCET is derived from differences between (a) the historical WCETs and the current WCET, and (b) the average WCET, respectively.

At block S702, a first sum value of the average WCET and the first standard deviation is obtained.

At block S703, the total WCET of the alternative combination is obtained by summing the first sum value of each first task in the alternative combination.

In the embodiment of the disclosure, considering the jitter of the calculation time of each network model, the average value t of WCET can be added with three times of 6, so that the stability of the system is further improved.

Alternatively, the total WCET can be calculated based on the EDF algorithm, and the calculation formula can be Σᵢ₌₁^{N}(tᵢ^{-j}+3δᵢ^{j}).

Based on the above embodiment, the first standard deviation of the plurality of historical WCETs and the current WCET is obtained. The first sum value of the average WCET and the first standard deviation is obtained. The total WCET of the alternative combination is obtained by summing the first sum value of each first task in the alternative combination. Therefore, the stability of the system can be increased and the influence of jitter on the system can be reduced based on the first sum value of the average WCET and the first standard deviation.

In the above embodiment, the process of obtaining the time consumption of the alternative combination according to the total WCET and the task processing cycle of the alternative combination is further explained in combination with FIG. 8. As illustrated in FIG. 8, the method includes the following steps.

At block S801, a historical task processing cycles are obtained.

In the embodiment of the disclosure, due to the jitter of the calculation time of each network model, the values of the plurality of the historical task processing cycles T may be different.

At block S802, an average task processing cycle is obtained based on the plurality of historical task processing cycles and the current task processing cycle.

In the embodiment of the disclosure, due to the jitter of the calculation time of each network model, the average task processing cycle is obtained by averaging the plurality of historical task processing cycles and the current task processing cycle.

At block S803, the time consumption of the alternative combination is determined based on the total WCET and the average task processing cycle.

The time consumption of the alternative combination is obtained based on the EDF algorithm according to formula (2):

$$s . t . {U}_{EDF} = \frac{{\sum }_{i = 1}^{N} ( {t}_{i}^{- j} + 3 {δ}_{i}^{j} )}{\overline{T}} \qquad ( 2 )$$

It can be seen from formula (2) that, compared with formula (1), the average task processing cycle T can reduce the influence of jitter of the task processing cycle on the system, make the system more balanced, so as to obtain more accurate alternative combinations.

In the above embodiment, the process of determining the time consumption of the alternative combination according to the total WCET and the average task processing cycle is further explained in combination with FIG. 9. As illustrated in FIG. 9, the method includes the following steps.

At block S901, a second standard deviation of the plurality of historical task processing cycles and the current task processing cycle is obtained.

In the embodiment of the disclosure, the second standard deviation μ can be obtained by calculating differences between (a) the plurality of historical task processing cycles and the current task processing cycle, and (b) the average task processing cycle, respectively.

At block S902, a second sum value of the average task processing cycle and the second standard deviation is obtained.

In the embodiment of the disclosure, due to the jitter of the calculation time of each network model, the second sum value may be generated by summing the task processing cycle and three times of the second standard deviation. In this way, the stability of the system can be enhanced.

At block S903, a ratio of the total WCET to the second sum value is determined as the time consumption of the alternative combination.

The time consumption of the alternative combination is obtained based on the EDF algorithm according to formula (3):

$$s . t . {U}_{EDF} = \frac{{\sum }_{i = 1}^{N} ( {t}_{i}^{- j} + 3 {δ}_{i}^{j} )}{\overline{T} + 3 μ} \qquad ( 3 )$$

It can be seen that, compared to formula (2), by summing the task processing cycle and three times of the second standard deviation, the impact of the fluctuation of the task processing cycle on the system can be reduced, so that the system is more stable.

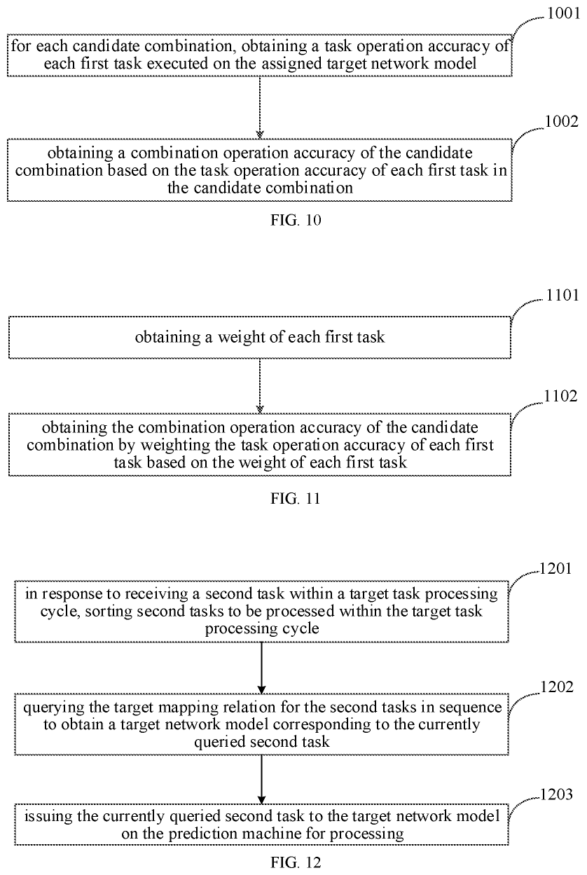

In the above embodiment, the method is further explained in combination with FIG. 10. As illustrated in FIG. 10, before selecting the target combination with the maximum combination operation accuracy from the at least one candidate combination, the method further includes the following steps.

At block S1001, for each candidate combination, a task operation accuracy of each first task executed on the assigned target network model is obtained.

Aⱼⁱ represents the task operation accuracy of the i^{th} task executed on the i^{th} network. In the embodiment of the disclosure, the task operation accuracy can be obtained based on a task operation accuracy processing algorithm.

It can be understood that, the larger the task operation accuracy of the task, the larger the accuracy of the result of processing the task by the model.

At block S1002, a combination operation accuracy of the candidate combination is obtained based on the task operation accuracy of each first task in the candidate combination.

Alternatively, the combination operation accuracy of the candidate combination can be obtained by formula (4).

$$ACC = {{\sum }^{N}}_{i} {A}_{j}^{i} \qquad ( 4 )$$

In the embodiment of the disclosure, for each candidate combination, the task operation accuracy of each first task executed on the assigned target network model is obtained, and then the combination operation accuracy of the candidate combination is obtained based on the task operation accuracy of each first task in the candidate combination. Therefore, by obtaining the accuracy of the first task executed on each assigned network model, the optimal network model for the first task can be found, and thus the target combination can be determined from the candidate combinations.

In the above embodiment, the process of obtaining the combination operation accuracy of the candidate combination according to the task operation accuracy of each task is further explained in combination with FIG. 11. As illustrated in FIG. 11, this method includes the following steps.

At block S1101, a weight of each first task is obtained.

In an implementation, the weight w of each first task is different. In order to improve the stability and accuracy of the system, the weight of the first task needs to be added to the system.

Alternatively, the weight w of each first task may be set in advance, and pre-stored in the storage space of the electronic device for use when needed.

Alternatively, by accessing a first task weight database, the weight of the first task can be obtained based on a mapping relation between the first tasks and the weights in the database. It should be noted that, the first task weight database may be stored in the storage space of the electronic device, or may be located on a server.

At block S1102, the combination operation accuracy of the candidate combination is obtained by weighting the task operation accuracy of each first task based on the weight of the first task.

Alternatively, the combination operation accuracy of the candidate combination can be obtained by formula (5).

$$ACC = {{\sum }^{N}}_{i} {w}_{i} {A}_{j}^{i} \qquad ( 5 )$$

It can be seen that the weight w of the first task is added in formula (5) compared to formula (4). The larger the weight of the first task, the larger the proportion of the accuracy of the task. As a result, the importance of the data can be increased, and the calculation result can be more accurate.

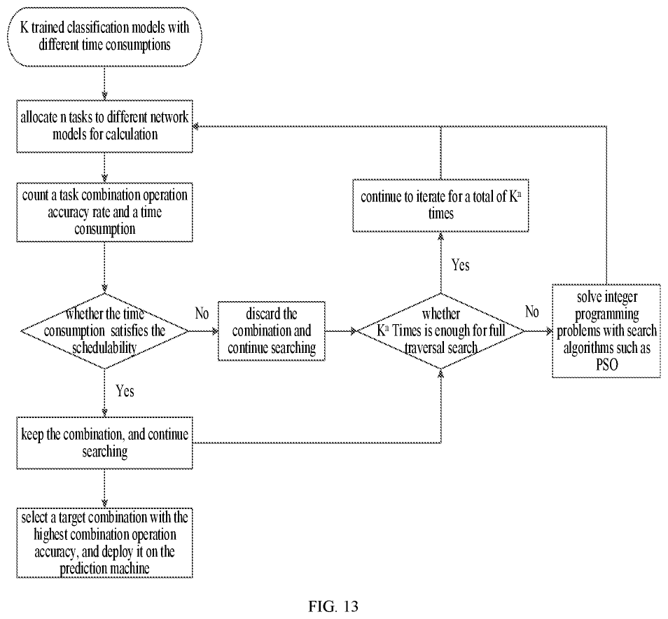

In the above embodiment, after the target mapping relation included in the target combination and the K network models are deployed on the prediction machine, subsequent steps can be further shown in combination with FIG. 12. As illustrated in FIG. 12, the method includes the following steps.

At block S1201, in response to receiving a second task within a target task processing cycle, second tasks to be processed within the target task processing cycle are sorted.

In the embodiment of the disclosure, in response to receiving a second task within the target task processing cycle, the second task may be classified firstly, and the second task may be grouped into a certain category of tasks.

It should be noted that the type of the second task is of the same type of the first task, to ensure that there is a mapping relation in the target mapping relation for such type.

At block S1202, the target mapping relation is queried for the second tasks in sequence to obtain a target network model corresponding to the second task.

In the embodiment of the disclosure, based on the type of the second task, the target network model corresponding to the type in the target combination can be obtained according to the target mapping relation.

At block 51203, the currently queried second task is issued to the target network model on the prediction machine for processing.

In the embodiment of the disclosure, firstly, in response to receiving a second task within a target task processing cycle, the second tasks to be processed within the target task processing cycle are sorted. The target network model corresponding to each second task to be processed is obtained by querying the target mapping relation for the second tasks in sequence. Finally, the second task to be processed is issued to the target network model on the prediction machine for processing. Therefore, the task type is determined, the prepared target network model can be obtained according to the target mapping relation, so that the method has high accuracy and strong schedulability.

In the embodiment of the disclosure, FIG. 13 is an overall flow chart of the multi-task deployment method. As illustrated in FIG. 13, firstly, n tasks are obtained and allocated to different network model combinations for calculation, and the combination operation accuracy and the time consumption are counted to determine whether the time consumption satisfies the schedulability. If the schedulability is satisfied, the current task-network model combination is saved, and a next task-network model combination is searched continuously. If the schedulability is not satisfied, the combination is discarded, the searching is continued, and it is determined whether the traverse search can be completed for k″ times. If the traverse search can be completed for k″ times, a total number of iterations is performed for k″ times. If the traverse search cannot be completed for k″ times, the search algorithm such as the PSO algorithm is used to obtain the available network model combinations from the network model combinations. The above steps are repeated until the traverse search is completed, and finally the combination with the maximum combination operation accuracy is selected from the above saved combinations and deployed to the prediction machine.

The embodiment of the disclosure also provides a multi-task deployment apparatus corresponding to the multi-task deployment method according to the above embodiments. Since the multi-task deployment apparatus according to the embodiments of the disclosure corresponds to the multi-task deployment method according to the above embodiments, the implementation manners of the multi-task deployment method are also applicable to the multi-task deployment apparatus according to the above embodiments, which will not be described in detail in the following embodiments.

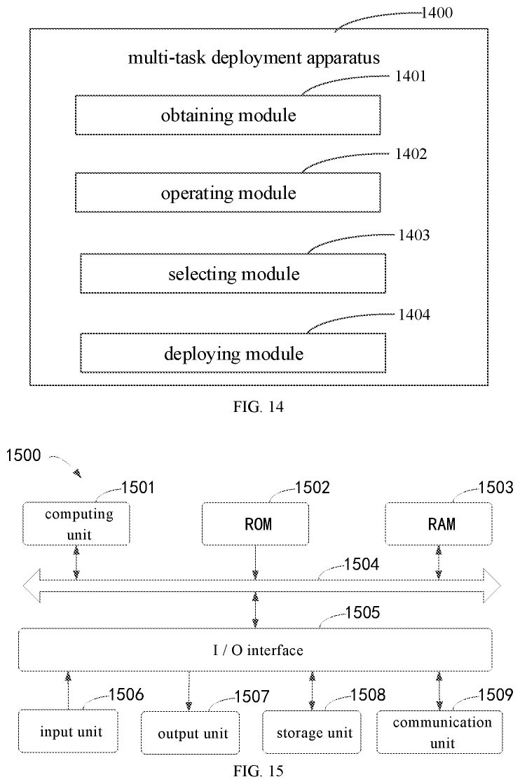

FIG. 14 is a block diagram of a multi-task deployment apparatus according to an embodiment of the disclosure.

As illustrated in FIG. 14, a multi-task deployment apparatus 1400 is provided. The apparatus 1400 includes: an obtaining module 1401, an operating module 1402, a selecting module 1403 and a deploying module 1404.

The obtaining module 1401 is configured to obtain N first tasks and K network models, in which N and K are positive integers greater than or equal to 1.

The operating module 1402 is configured to allocate the N first tasks to the K network models for operation, to obtain at least one candidate combination of tasks and network models, in which each candidate combination includes a mapping relation between the N first tasks and the K network models.

The selecting module 1403 is configured to select a target combination with a maximum combination operation accuracy from the at least one candidate combination.

The deploying module 1404 is configured to deploy a target mapping relation included in the target combination and the K network models on a prediction machine.

In an embodiment of the disclosure, the operating module 1402 is further configured to: in response to the N first tasks being allocated, obtain a time consumption of task execution of an alternative combination of the tasks and the network models obtained by allocating of the N first tasks; and in response to the time consumption of the alternative combination satisfying a schedulable constraint parameter, determine the alternative combination as the candidate combination.

In an embodiment of the disclosure, the operating module 1402 is further configured to: in response to the time consumption of the alternative combination not satisfying the schedulable constraint parameter, discard the alternative combination and obtain a next alternative combination.

In an embodiment of the disclosure, the operating module 1402 is further configured to: determine a total number of iterations based on N and K; and in response to the total number of iterations being greater than an iteration number threshold, search for a next alternative combination through a PSO algorithm based on a combination operation accuracy of the alternative combination.

In an embodiment of the disclosure, the operating module 1402 is further configured to: obtain a present WCET of each first task of the N first tasks in the alternative combination when the first task is executed on an assigned target network model; and obtain the time consumption of the alternative combination based on the present WCET of each first task and a present task processing cycle.

In an embodiment of the disclosure, the operating module 1402 is further configured to: obtain a total WCET of the alternative combination based on the present WCET of each first task; and obtain the time consumption of the alternative combination based on the total WCET of the alternative combination and the present task processing cycle.

In an embodiment of the disclosure, the operating module 1402 is further configured to: for each first task, obtain a plurality of historical WCETs of the target network model corresponding to the first task; obtain an average WCET of the first task on the target network model based on the plurality of historical WCETs and the present WCET; and obtain the total WCET of the alternative combination based on the average WCET of each first task.

In an embodiment of the disclosure, the operating module 1402 is further configured to: obtain a first standard deviation of the plurality of historical WCETs and the present WCET; obtain a first sum value of the average WCET and the first standard deviation; and obtain the total WCET of the alternative combination by summing the first sum value of each first task in the alternative combination.

In an embodiment of the disclosure, the operating module 1402 is further configured to: obtain a plurality of historical task processing cycles; obtain an average task processing cycle based on the plurality of historical task processing cycles and the present task processing cycle; and determine the time consumption of the alternative combination based on the total WCET and the average task processing cycle.

In an embodiment of the disclosure, the operating module 1402 is further configured to: obtain a second standard deviation of the plurality of historical task processing cycles and the present task processing cycle; obtain a second sum value of the average task processing cycle and the second standard deviation; and obtain a ratio of the total WCET to the second sum value as the time consumption of the alternative combination.

In an embodiment of the disclosure, before selecting the target combination with the maximum combination operation accuracy rate from the at least one candidate combination, the apparatus is further configured to: for each candidate combination, obtain a task operation accuracy of each first task executed on the assigned target network model; and obtaining a combination operation accuracy of the candidate combination based on the task operation accuracy of each first task in the candidate combination.

In an embodiment of the disclosure, obtaining the combination operation accuracy of the candidate combination based on the task operation accuracy of each first task in the candidate combination, includes: obtaining a weight of each first task; and obtaining the combination operation accuracy of the candidate combination by weighting the task operation accuracy of each first task based on the weight of each first task.

In an embodiment of the disclosure, after deploying the target mapping relation included in the target combination and the K network models on the prediction machine, the apparatus is further configured to: in response to receiving a second task within a target task processing cycle, sorting second tasks to be processed within the target task processing cycle; querying the target mapping relation for the second tasks in sequence to obtain a target network model corresponding to the currently queried second task; and issuing the currently queried second task to the target network model on the prediction machine for processing.

According to the embodiments of the disclosure, the disclosure provides an electronic device, and a readable storage medium and a computer program product.

FIG. 15 is a block diagram of an example electronic device 1500 used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 15, the electronic device 1500 includes: a computing unit 1501 performing various appropriate actions and processes based on computer programs stored in a read-only memory (ROM) 1502 or computer programs loaded from the storage unit 1508 to a random access memory (RAM) 1503. In the RAM 1503, various programs and data required for the operation of the device 1500 are stored. The computing unit 1501, the ROM 1502, and the RAM 1503 are connected to each other through a bus 1504. An input/output (I/O) interface 1505 is also connected to the bus 1504.

Components in the device 1500 are connected to the I/O interface 1505, including: an inputting unit 1506, such as a keyboard, a mouse; an outputting unit 1507, such as various types of displays, speakers; a storage unit 1508, such as a disk, an optical disk; and a communication unit 1509, such as network cards, modems, and wireless communication transceivers. The communication unit 1509 allows the device 1500 to exchange information/data with other devices through a computer network such as the Internet and/or various telecommunication networks.

The computing unit 1501 may be various general-purpose and/or dedicated processing components with processing and computing capabilities. Some examples of computing unit 1501 include, but are not limited to, a CPU, a graphics processing unit (GPU), various dedicated AI computing chips, various computing units that run machine learning model algorithms, and a digital signal processor (DSP), and any appropriate processor, controller and microcontroller. The computing unit 1501 executes the various methods and processes described above, such as the multi-task deployment method. For example, in some embodiments, the method may be implemented as a computer software program, which is tangibly contained in a machine-readable medium, such as the storage unit 1508. In some embodiments, part or all of the computer program may be loaded and/or installed on the device 1500 via the ROM 1502 and/or the communication unit 1509. When the computer program is loaded on the RAM 1503 and executed by the computing unit 1501, one or more steps of the method described above may be executed. Alternatively, in other embodiments, the computing unit 1501 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and the block-chain network.

The computer system may include a client and a server. The client and server are generally remote from each other and interacting through a communication network. The client-server relation is generated by computer programs running on the respective computers and having a client-server relation with each other. The server may be a cloud server, a server of a distributed system, or a server combined with a block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

1. A multi-task deployment method, comprising:
obtaining N first tasks and K network models, wherein N and K are positive integers greater than or equal to 1;
allocating the N first tasks to the K network models for operation, to obtain at least one candidate combination of tasks and network models, wherein each candidate combination comprises a mapping relation between the N first tasks and the K network models;
selecting a target combination with a maximum combination operation accuracy from the at least one candidate combination; and
deploying a target mapping relation comprised in the target combination and the K network models on a prediction machine.

2. The method of claim 1, wherein allocating the N first tasks to the K network models for operation, to obtain the at least one candidate combination of the tasks and the network models, comprises:
in response to the N first tasks being allocated, obtaining a time consumption of task execution of an alternative combination of the tasks and the network models obtained by allocating of the N first tasks; and
in response to the time consumption of the alternative combination satisfying a schedulable constraint parameter, determining the alternative combination as the candidate combination.

3. The method of claim 2, further comprising:
in response to the time consumption of the alternative combination not satisfying the schedulable constraint parameter, discarding the alternative combination and obtaining a next alternative combination.

4. The method of claim 2, further comprising:
determining a total number of iterations based on N and K; and
in response to the total number of iterations being greater than an iteration number threshold, searching for a next alternative combination through a Particle Swarm Optimization (PSO) algorithm based on a combination operation accuracy of the alternative combination.

5. The method of claim 2, wherein obtaining the time consumption of task execution of the alternative combination of the tasks and the network models obtained by allocating of the N first tasks comprises:
obtaining a present Worst Case Execution Time (WCET) of each first task of the N first tasks in the alternative combination when the first task is executed on an assigned target network model; and
obtaining the time consumption of the alternative combination based on the present WCET of each first task and a present task processing cycle.

6. The method of claim 5, wherein obtaining the time consumption of the alternative combination based on the present WCET of each first task and the present task processing cycle, comprises:
obtaining a total WCET of the alternative combination based on the present WCET of each first task; and
obtaining the time consumption of the alternative combination based on the total WCET of the alternative combination and the present task processing cycle.

7. The method of claim 6, wherein obtaining the total WCET of the alternative combination based on the present WCET of each first task comprises:
for each first task, obtaining a plurality of historical WCETs of the target network model corresponding to the first task;
obtaining an average WCET of the first task on the target network model based on the plurality of historical WCETs and the present WCET; and
obtaining the total WCET of the alternative combination based on the average WCET of each first task.

8. The method of claim 7, wherein obtaining the total WCET of the alternative combination based on the average WCET of each first task, comprises:
obtaining a first standard deviation of the plurality of historical WCETs and the present WCET;
obtaining a first sum value of the average WCET and the first standard deviation; and
obtaining the total WCET of the alternative combination by summing the first sum value of each first task in the alternative combination.

9. The method of claim 6, wherein obtaining the time consumption of the alternative combination based on the total WCET of the alternative combination and the present task processing cycle comprises:
obtaining a plurality of historical task processing cycles;
obtaining an average task processing cycle based on the plurality of historical task processing cycles and the present task processing cycle; and
determining the time consumption of the alternative combination based on the total WCET and the average task processing cycle.

10. The method of claim 9, wherein determining the time consumption of the alternative combination based on the total WCET and the average task processing cycle, comprises:
obtaining a second standard deviation of the plurality of historical task processing cycles and the present task processing cycle;
obtaining a second sum value of the average task processing cycle and the second standard deviation; and
obtaining a ratio of the total WCET to the second sum value as the time consumption of the alternative combination.

11. The method of claim 1, wherein before selecting the target combination with the maximum combination operation accuracy from the at least one candidate combination, the method further comprises:
for each candidate combination, obtaining a task operation accuracy of each first task executed on the assigned target network model; and
obtaining a combination operation accuracy of the candidate combination based on the task operation accuracy of each first task in the candidate combination.

12. The method of claim 1, wherein obtaining the combination operation accuracy of the candidate combination based on the task operation accuracy of each first task in the candidate combination, comprises:
obtaining a weight of each first task; and
obtaining the combination operation accuracy of the candidate combination by weighting the task operation accuracy of each first task based on the weight of each first task.

13. The method of claim 1, wherein after deploying the target mapping relation comprised in the target combination and the K network models on the prediction machine, the method further comprises:
in response to receiving a second task within a target task processing cycle, sorting second tasks to be processed within the target task processing cycle;
querying the target mapping relation for the second tasks in sequence to obtain a target network model corresponding to the currently queried second task; and
issuing the currently queried second task to the target network model on the prediction machine for processing.

14. An electronic device, comprising:
at least one processor; and
a memory communicatively coupled to the at least one processor; wherein,
the memory stores instructions executable by the at least one processor, when the instructions are executed by the at least one processor, the at least one processor is enabled to implement the following operations, comprising:
obtaining N first tasks and K network models, wherein N and K are positive integers greater than or equal to 1;
allocating the N first tasks to the K network models for operation, to obtain at least one candidate combination of tasks and network models, wherein each candidate combination comprises a mapping relation between the N first tasks and the K network models;
selecting a target combination with a maximum combination operation accuracy from the at least one candidate combination; and
deploying a target mapping relation comprised in the target combination and the K network models on a prediction machine.

15. The device of claim 14, wherein allocating the N first tasks to the K network models for operation, to obtain the at least one candidate combination of the tasks and the network models, comprises:
in response to the N first tasks being allocated, obtaining a time consumption of task execution of an alternative combination of the tasks and the network models obtained by allocating of the N first tasks; and
in response to the time consumption of the alternative combination satisfying a schedulable constraint parameter, determining the alternative combination as the candidate combination.

16. The device of claim 15, wherein the following operations further comprises:
determining a total number of iterations based on N and K; and
in response to the total number of iterations being greater than an iteration number threshold, searching for a next alternative combination through a Particle Swarm Optimization (PSO) algorithm based on a combination operation accuracy of the alternative combination.

17. The device of claim 15, wherein obtaining the time consumption of task execution of the alternative combination of the tasks and the network models obtained by allocating of the N first tasks comprises:
obtaining a present Worst Case Execution Time (WCET) of each first task of the N first tasks in the alternative combination when the first task is executed on an assigned target network model; and
obtaining the time consumption of the alternative combination based on the present WCET of each first task and a present task processing cycle.

18. The device of claim 14, wherein before selecting the target combination with the maximum combination operation accuracy from the at least one candidate combination, the following operations further comprises:
for each candidate combination, obtaining a task operation accuracy of each first task executed on the assigned target network model; and
obtaining a combination operation accuracy of the candidate combination based on the task operation accuracy of each first task in the candidate combination.

19. The device of claim 14, wherein after deploying the target mapping relation comprised in the target combination and the K network models on the prediction machine, the following operations further comprises:
in response to receiving a second task within a target task processing cycle, sorting second tasks to be processed within the target task processing cycle;
querying the target mapping relation for the second tasks in sequence to obtain a target network model corresponding to the currently queried second task; and
issuing the currently queried second task to the target network model on the prediction machine for processing.

20. A non-transitory computer-readable storage medium having computer instructions stored thereon, wherein the computer instructions are configured to cause a computer to implement the method of claim 1.
